(19) United States
(12) Patent Application Publication
(10) Pub. No.: US 2015/0173345 A1
(43) Pub. Date: Jun. 25, 2015

(54) RODENT BAIT STATION AND RELATED METHODS

(71) Applicants: Wayne R. Morris, Louisville, OH (US); Blaine H. Morris, East Sparta, OH (US)

(72) Inventors: Wayne R. Morris, Louisville, OH (US); Blaine H. Morris, East Sparta, OH (US)

(21) Appl. No.: 13/922,454

(22) Filed: Jun. 20, 2013

Related U.S. Application Data
(60) Provisional application No. 61/662,206, filed on Jun. 20, 2012.

(51) Int. Cl. A01M 25/00

(52) U.S. Cl. CPC A01M 25/004

(57) ABSTRACT

A rodent bait station capable of efficiently holding and retaining one or more rodenticide blocks includes a spanning element between two vertically disposed uprights. The spanning element is adapted so that, in use, it can hold and retain one or more rodenticide blocks which are free to rotate while a rodent is feeding thereon. The article can include a removable cover designed or adapted to protect the article from unintended access.

### CROSS-REFERENCE TO RELATED APPLICATION

This application claims the benefit of U.S. provisional patent application No. 61/662,206, filed Jun. 20, 2012, which is incorporated herein by reference in its entirety.

### BACKGROUND INFORMATION

Rodents have afflicted mankind for millennia and are responsible for a variety of diseases and afflictions, many of which are deadly.

Despite myriad efforts to control their populations, rodents are ubiquitous. In 1922, The New York Times reported that the number of people living in Boston had been exceeded by the number of rats. A 1998 issue of The New Yorker estimated that more than 28,000,000 rats could be found within the city limits of New York.

The desire to control rodent populations is so important and widespread that “building a better mousetrap” is forever engrained as an English language idiom.

Innumerable ways to kill or trap rodents have been developed over the years. For those who fear rodents, mechanical (e.g., snap) and glue traps have the disadvantage of retaining the rodent at the location of the trap. People with an aversion to seeing rodents, dead or alive, prefer poisoned baits (rodenticides), specifically, so-called second generation rodenticides which act as anticoagulants, killing the rodent after it leaves the point of ingestion.

Many anticoagulant-type rodenticides are in solid block form, as opposed to pellets or flakes. These rodenticide blocks often are in the form of solid cylinders or rectangular prisms, many of which have a hole or passage running the length of the block.

Feeding stations have been designed for use with these solid block rodenticides. Typically, the rodenticide blocks are placed in a portion of a closable container with a portal for the rodent. Some of the containers include vertical spindles on which the blocks can be placed and retained, i.e., to prevent the rodenticide from being carried away.

The foregoing type of station or trap has certain inherent drawbacks. First, as suggested above, rodents often transport the rodenticide to another location, thereby requiring frequent replacement of bait. Second, many people have such a fear of rodents that they will not open the container to check whether the bait needs to be refilled because they fear that a rodent, dead or alive, might be inside.

A feeding station that prevents removal of rodenticide and permits quick and easy evaluation remains desirable.

### SUMMARY

The articles provided herein, as well as methods employing them, are of simple, elegant design. This simplicity permits efficient, cost effective production and cost efficient use. The articles effectively retain block type rodenticides, thereby preventing the bait from being removed by the rodent. Further, it is designed so that the presence or absence of a rodent can be determined visually from a safe distance, thereby eliminating the need for a human user to approach the station while not knowing whether a rodent might be inside.

In one aspect is provided an article capable of efficiently holding and retaining one or more rodenticide blocks. The article can include two vertically disposed uprights, a crosspiece connecting the tops of the two uprights, and a spanning element spaced apart from and disposed below the crosspiece. The spanning element can be fixedly connected to one upright and removably connected to the other, or removably connected to both. The spanning element is adapted so that, in use, it can hold and retain one or more rodenticide blocks while a rodent is feeding thereon.

The article can include a removable cover designed or adapted to protect the article from unintended access by, for example, pets or children. The cover can permit entry and egress by a rodent while otherwise restricting access.

In another aspect is provided the foregoing article in combination with rodenticide, as well as a kit containing these components. The rodenticide optionally can be provided with a hole or tunnel along its longitudinal axis, or the kit optionally can be provided with an implement capable of creating such a void in a rodenticide not already containing one.

In another aspect is provided a method of providing a rodenticide to rodents. The method involves providing rodenticide on a horizontally disposed high aspect ratio element, such as a wire or rod. The horizontally disposed element and rodenticide are configured so as to permit the latter to rotate around the longitudinal axis of the former while a rodent is feeding on the rodenticide. The horizontally disposed element optimally is located above the level that the rodent(s) of interest can reach while having all four of its feet on the ground or base of the article. At least in some embodiments, the horizontally disposed element is too high to permit the rodent to rest its front feet on the horizontally disposed element while feeding.

Other aspects will be apparent from the accompanying figures and the more detailed description that follows.

### BRIEF DESCRIPTION OF THE DRAWINGS

Illustrative configurations set forth in the description that follows are shown in the drawings, where similar numbers refer to similar parts or features. The figures are not necessarily to scale.

FIG. 1 is a front view of one configuration of a rodent bait station article according to the present invention.

FIG. 2 is a top perspective view of a rodent bait station article according to the present invention.

FIG. 3 is a side perspective view of a rodent bait station article according to the present invention.

FIG. 4 is a side perspective view of another configuration of a rodent bait station article according to the present invention.

FIG. 5 is an end view of a rodent bait station article according to the present invention.

FIG. 6 is a front view of exemplary rodenticide that can be used in conjunction with the rodent bait station article of the present invention.

### DETAILED DESCRIPTION OF ILLUSTRATIVE EMBODIMENTS

The following description is provided to explain and exemplify the efficiency enhancement achieved by providing a horizontally disposed element that can hold a torus-like rodenticide. It describes exemplary configurations and methods of operation. The appended claims define the inventions in which exclusive rights are claimed, and they are not to be limited to particular embodiments shown and described.

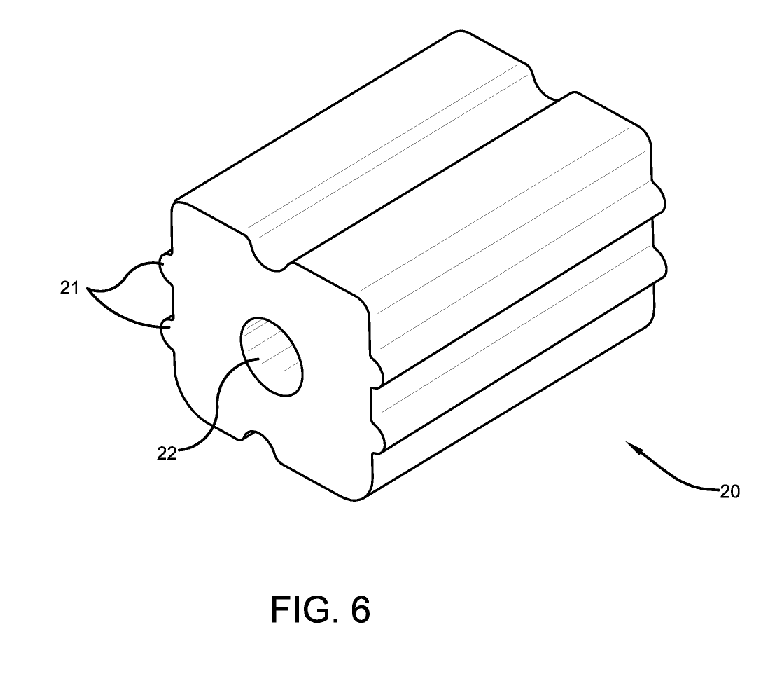

An exemplary configuration of rodenticide that can be used in connection with the rodent bait station article of the present invention is depicted in FIG. 6. Rodenticide 20 has longitudinal flutes or ridges 21, although those are optional. Commercially available rodenticides are available from a variety of sources, non-limiting examples of which include RAMIK™ (Neogen Corp.; Lexington, Ky.), HAVOC™ (Rainbow Technology Corp.; Pelham, Ala.), and JUST ONE BITE™ (Farnam Companies, Inc.; Phoenix, Ariz.).

Rodenticide 20 includes passage or void 22 that extends along a longitudinal axis. The rodenticide can be provided with the depicted longitudinal passage, or a solid form can be used if modified to include such a passage. Additionally, the passage need not run along the longest axis of the rodenticide; for example, if the longest axis of the rodenticide is deemed to be the x axis, the passage alternatively can run along either of the y or z axes or can be cut on a bias.

The chemical composition of the rodenticide is not particularly important to the operation of the bait station article or the efficacy of the method. For a variety of reasons, those rodenticides which act via an anticoagulant mechanism can be preferred where the user does not wish to see a dead rodent in the vicinity of a bait station article.

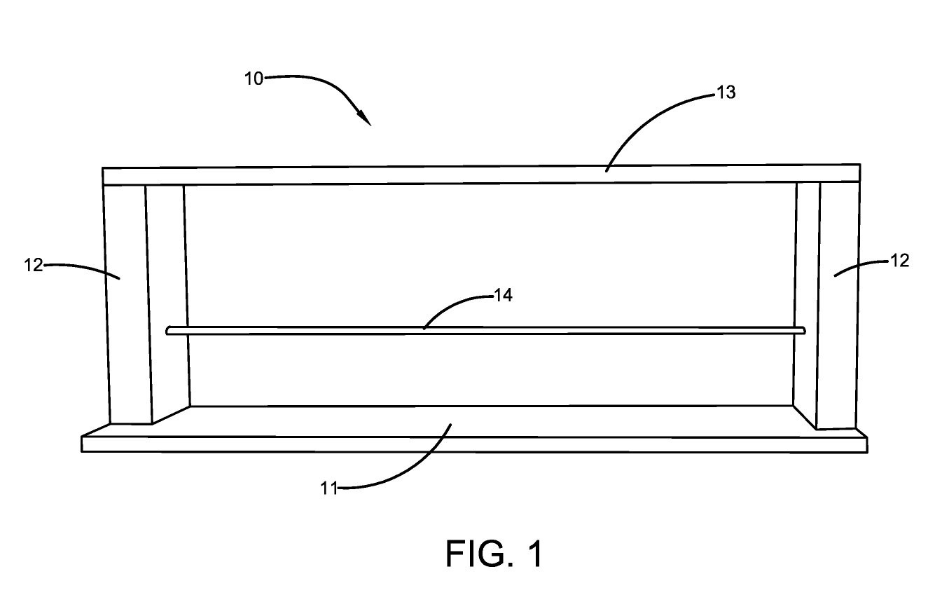

Depicted in FIGS. 1, 2 and 3 is rodent bait station article 10 which generally includes base 11, uprights 12, crosspiece 13, and horizontal spanning element 14. In alternative arrangements, either or both of base 11 and crosspiece 13 can be optional.

In FIGS. 1-3, each of base 11, uprights 12, and crosspiece 13 is shown as being formed from wood, specifically, a composite wood product such as UDF, pressboard, particle-board, plywood, or the like. This is a matter of convenience and design choice. One or more of the pieces also can be made from any of a variety of materials including, but not limited to, plastics, elastomers, metals, ceramics, and composites. In certain embodiments, one or more of these components can be provided from a biodegradable or compostable material. Additionally, one or more of these components can be provided in non-solid form, i.e., all or portions can be hollow.

Although optional, base 11 is preferred because it provides stability to article 10, can provide some protection against water damage to uprights 12 where the latter are made from a porous material such as wood, and, where wider than the distance to horizontal spanning element 14, can keep rodenticide off the ground if article 10 is overturned. The desired amount of stability alternatively might be able to be provided by flaring the bottom portions of uprights 12, providing feet or the like to uprights 12, adding cross braces to uprights 12, and the like.

Height of base 11 can range from ˜2-3 mm up to ˜5 cm or more; this variable is limited only by the ability of the target rodent(s) to be able to reach the upper surface of base 11. Where the height of base 11 permits and where some or all of base 11 is hollow, article 10 can serve multiple purposes; for example, base 11 can act to hold bait or poison for another type of pest (e.g., roach or termite) or be used to temporarily store rodent feces (for example, with base 11 acting as frame for a slidable tray, optionally with a pull or knob to facilitate removal).

Width of base 11 can vary widely, although generally will be no less than ˜5 cm and no more than ˜75 cm. Width of base 11 typically is at least ˜7 cm, ˜10 cm, ˜12 cm, or even ˜15 cm, and typically is no more than ˜70 cm, ˜65 cm, ˜60 cm, or even ˜50 cm. (Combinations of the foregoing minimum and maximum values can be used to form preferred width ranges.) An exemplary range of widths is 30 cm±30%, preferably ±20%.

Depth of base 11 also can vary widely, although generally will be no less than ˜5 cm and no more than ˜40 cm. Depth of base 11 typically is at least ˜7 cm, ˜10 cm, ˜12 cm, or even ˜15 cm, and typically is no more than ˜35 cm, ˜30 cm, ˜25 cm, or even ˜20 cm. (Combinations of the foregoing minimum and maximum values can be used to form preferred depth ranges.) An exemplary range of depths is 15 cm±30%, preferably ±20%.

As depicted, the upper surface of base 11 is flat, although this is not mandatory. For example, the upper surface can be provided with a relatively small amount of slope (e.g., a grade of no more than ˜20%, commonly no more than ˜10%, and typically no more than ˜5%) and, in some instances, this can be preferred.

Base 11 also can include connectors on opposite ends to permit multiple articles to be joined.

Crosspiece 13 also is optional, although preferred. Inclusion of crosspiece 13 provides additional stability to uprights 12 as well as a convenient piece to grip during placement and transportation of bait station article 10. In view of the foregoing, crosspiece 13 can include grooves, helices, or other grip aids and/or can be provided with a tactile (e.g., rubber or foam) insert or covering.

Crosspiece 13 need not be positioned at the top of uprights 12; if desired, article 10 can be designed and manufactured such that uprights 12 extend above crosspiece 13. Similarly, crosspiece 13 need not be coextensive with uprights 12, i.e., crosspiece 13 can extend beyond one or both of uprights 12 or extend only partially between uprights 12, i.e., be cantilevered from one upright.

Additionally, crosspiece 13 need not be straight in each of the x, y or z axes. Curves and/or bends can be included if desired. Additionally, crosspiece 13 can present a cross section that is circular, oval, etc.

Crosspiece 13 also can be provided with enhanced tactility to facilitate movement of article 10. Enhanced tactility can be provided by a friction surface, a padded surface, grooves or raised ridges, etc.

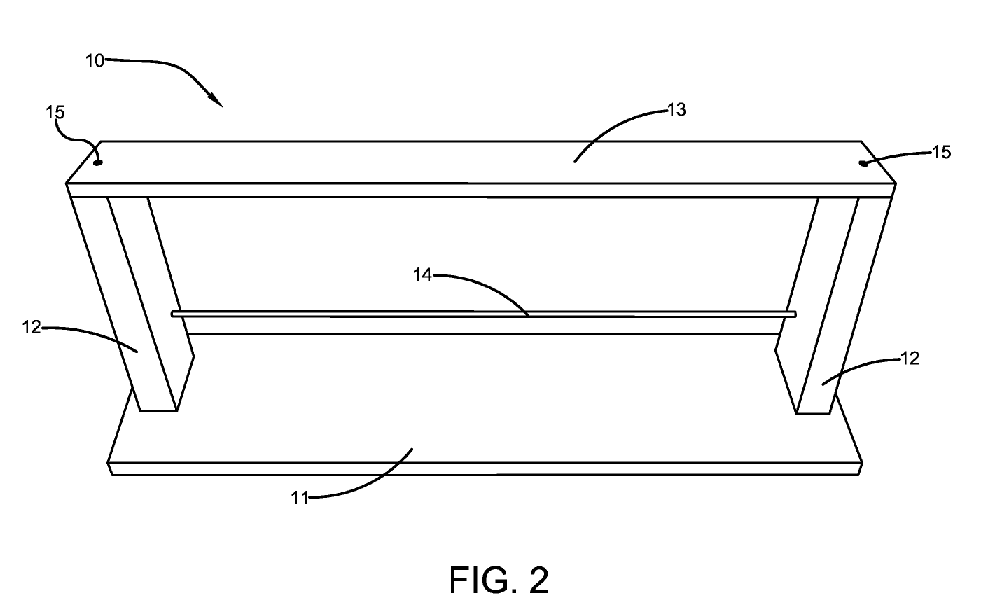

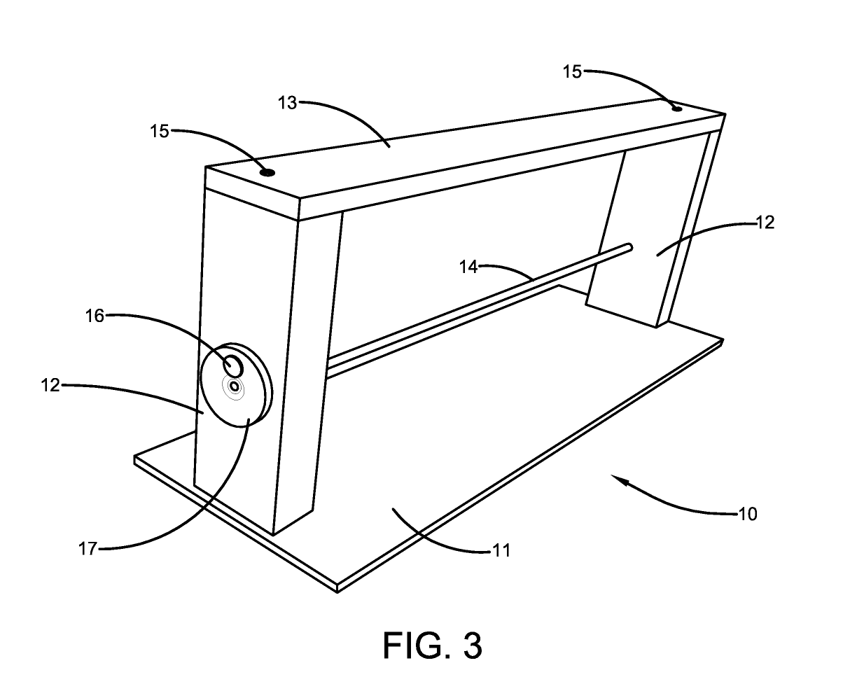

As depicted in FIGS. 2 and 3, crosspiece 13 is attached to uprights 12 by staples. This is exemplary and any of a wide variety of fastening mechanisms or devices such as screws, nails, adhesives, etc., can be employed.

In certain embodiments, the combination of uprights 12 and crosspiece 13 can be provided as a unitary piece. This might be preferred where article 10 is made from molded thermoplastic(s) or a metal.

Uprights 12 inter alia provide supports for horizontal spanning element 14. Accordingly, each upright 12 preferably is tall enough to ensure that horizontal spanning element 14 is high enough above the ground or upper surface of base 11 that the targeted species of rodent must stand on its hind legs to feed and, preferably, located such that the rodent cannot use its front feet to hold the rodenticide (for reasons discussed below). By way of non-limiting example, for a common field mouse, horizontal spanning element 14 can be placed ˜4 to ˜8 cm above the ground or upper surface of base 11 and, accordingly, uprights 12 are at least that tall relative to the ground or upper surface of base 11. (A bait station article intended for use with a larger rodent will employ uprights that are proportionally taller.) Height of uprights 12 commonly range from ˜3 to ˜30 cm, more commonly from ˜4 to ˜25 cm, typically from ˜5 to ˜20 cm, and most typically from ˜5 to ˜15 cm.

Uprights 12 typically are placed near the midpoint of the depth of base 11, although this is not mandatory. For example, where an article is to be placed against a wall or upright surface, positioning uprights off-center, e.g., closer to the back of base 11, might be preferred.

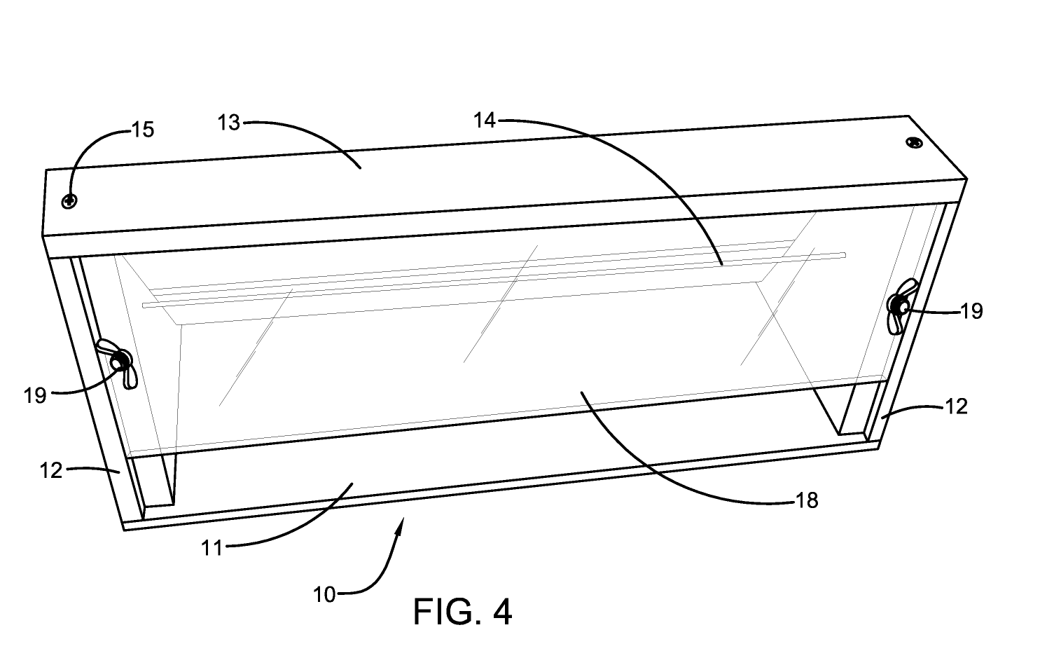

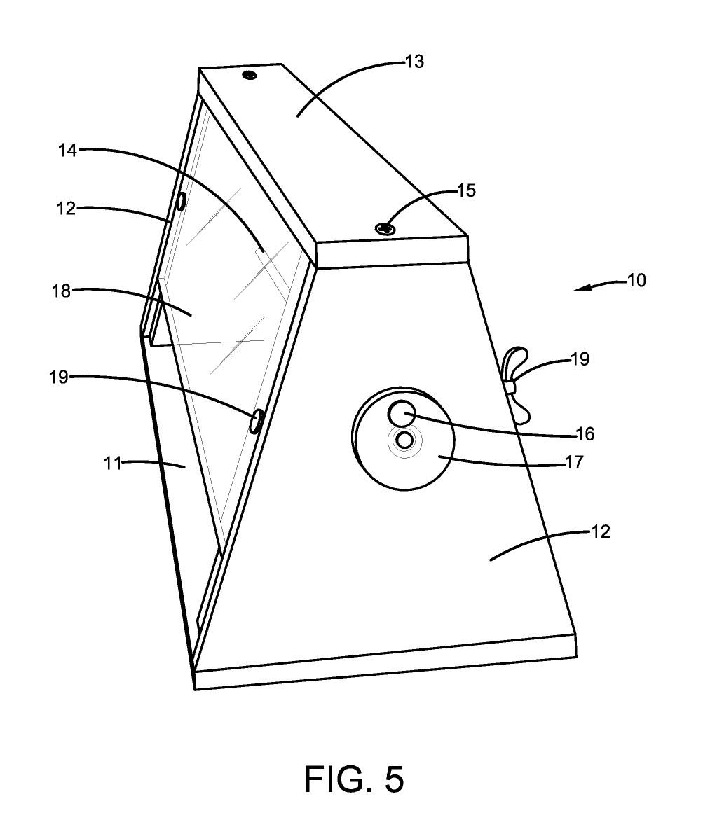

Uprights 12 can present a rectangular, square, circular, oval, triangular, polygonal, or even irregular cross section. Uprights 12 present a rectangular cross section in FIGS. 1-3 and trapezoidal cross section in FIGS. 4-5.

More than one pair of uprights 12 can be provided on base 11. Alternatively or additionally, uprights 12 can be shaped like a cross or can have rods extending perpendicularly for use as attachment points for multiple horizontal spanning elements 14. In such situations, each horizontal spanning element 14 should be spaced at least one rodenticide diameter from the other(s).

In certain embodiments, the combination of uprights 12 and base 11 can be provided as a unitary piece. This might be preferred where article 10 is made from molded thermoplastic(s) or a metal.

Where uprights 12 are not integral with base 11, they can connect in any of a variety of ways, determined primarily by the type of material from which each is made. Connection options include, but are not limited to, snap fit, screw in, slide and lock, hinged, hook-and-loop fastening, staples, nails, adhesives, etc.

Horizontal spanning element 14 preferably is substantially inextensible, i.e., does not swag or droop under the weight of rodenticide or even a supported rodent. Certain small diameter rods and large diameter wires meet this requirement; smaller diameter wires also might find utility if twisted or otherwise reinforced. Alternatively, spring steel, which returns to its original shape and dimensions after bending, also can be used. If a rod is used, it can be made from any of a variety of materials including metal, wood, composite, ceramic, plastic, etc.

The diameter of horizontal spanning element 14 must be less than the diameter of the passage in a rodenticide used in connection therewith.

The gap between horizontal spanning element 14 and crosspiece 13 (when present) is great enough to permit rodenticide to rotate freely and to permit a rodent to feed without being impeded.

In certain embodiments, the combination of uprights 12 and horizontal spanning element 14 can be provided as a unitary, albeit separable, piece. For example, where each upright 12 is formed as an angled wire or rod (e.g., two right angles), the ends of the uprights distal from base 11 can meet and, where one or both includes a connecting mechanism or piece, the two can join to form a unitary piece.

Where horizontal spanning element 14 is distinct from uprights 12, the former can attach to the latter in a variety of ways. In FIG. 3, the end of spanning element 14 connecting to the more distant upright is fixedly attached while the end connecting to the closer upright is removably attached. In this embodiment, fastener 16 and rotatable retaining cap 17 act to cover the proximal end of spanning element 14, which sits in a cavity of upright 12. When fastener 16 is loosened and cap 17 moved (rotated), spanning element 14 can be swung free from upright 12 to permit rodenticide to be loaded thereon prior to re-rotation of cap 17 and tightening of fastener 16.

In addition to the connecting mechanism shown in FIG. 3, alternative methods for removably attaching spanning element 14 to uprights 12 are envisioned. These include, but are not limited to, a tortuous path for one or both ends of spanning element 14, one or two spring loaded ends to spanning element 14, a replaceable cap (similar to the backing of an earring), a double-headed nail with a retaining clip, a turn-latch combination, and the like.

Rodent bait station article 10 advantageously provides a way to prevent rodenticide from being wasted. When rodenticide is supported on horizontal spanning element 14, the rodenticide turns or spins relatively freely, and this prevents a rodent from chewing through one side and taking the remainder to its nest or some other feeding area. This is in contrast even to stations employing vertical spindles because, in those, the rodent can hold the rodenticide and gnaw through one side.

By providing rodenticide on a horizontally disposed, high aspect ratio element, such as a wire or rod, around which the rodenticide can rotate while a rodent is feeding thereon, the amount of rodenticide available at the site of the article is maximized and premature removal of rodenticide is minimized or even prevented. By locating the horizontally disposed element optimally above the level that the rodent(s) of interest can reach while flat-footed, and even where its front feet can reach, the rodent must feed on a continuously rotating source.

Although not shown in FIGS. 1-3, article 10 can be provided with a protective cover. One embodiment of a rodent bait station article providing relatively inaccessible rodenticide is presented in FIGS. 4-5 where covering face 18 protects against human access to horizontal spanning element 14 while still providing sufficient clearance from base 11 to permit access by a rodent access. In FIG. 4, covering face 18 is attached to one side of upright 12 via easily removable covering face retainer 19 (e.g., wing nut). In FIG. 5, the opposite covering face 18 is attached to the opposite side of upright 12 via covering face retainer 19 (e.g., screw).

Other embodiments of a cover can be removably attached or hinged. It also can be of unitary or non-unitary design. Such a cover can include a gap under which a rodent can squeeze itself and/or a void through which a rodent can pass. Both can be configured to prevent access to the rodenticide by animals such as cats or dogs and/or by children.

Where a cover is included, such a cover preferably is at least partially transparent, or provided with a sufficiently sized viewing window, to permit a human observer to be able to see whether a rodent is under the cover.

A combination or kit that includes article 10 also can include one or more pieces or blocks of rodenticide. Where the rodenticide does not include a spanning passage, a tool to create such a passage also can be included or, in some embodiments, spanning element 14 can be formed in such a way so as to permit it to be used for a similar purpose. Where the article includes a base and the base's configuration permits, the combination also can include a brush and/or pest bait (e.g., bait for roaches, ants, termites, etc.). The combination also can include spare parts (e.g., an additional spanning element), cleaning supplies and/or equipment, printed instructions, and the like.

The following table summarizes in list form the terms and phrases used to identify suitable parts and materials.

TABLE 1
List of reference symbols

| Number | Description |
|---|---|
| 10 | bait trap station |
| 11 | base |
| 12 | upright |
| 13 | crosspiece |
| 14 | horizontal spanning element |
| 15 | connector |
| 16 | fastener |
| 17 | protector |
| 18 | covering face |
| 19 | covering face retainer |
| 20 | rodenticide |
| 21 | edge flute |
| 22 | passage |

The foregoing description has employed certain terms and phrases for the sake of brevity, clarity, and ease of understanding; no unnecessary limitations are to be implied therefrom because such terms are used for descriptive purposes and are intended to be broadly construed.

The foregoing configurations and methods have been presented by way of example only. Certain features of the described configurations and methods may have been described in connection with only one or a few such configurations or methods, but they should be considered as being useful in other such configurations or methods unless their structure or use is incapable of adaptation for such additional use. Also contemplated are combinations of features described in isolation.

That which is claimed is:

1. An article capable of efficiently holding and retaining one or more rodenticide blocks, said article comprising two vertically disposed uprights, a crosspiece connecting the tops of the two uprights, and a spanning element extending between said uprights, said spanning element being spaced apart from and disposed below the crosspiece and being adapted so that, in use, one or more of said rodenticide blocks can be disposed and retained thereon while said blocks are fed upon by a rodent.

2. The article of claim 1 wherein said spanning element is fixedly connected to one of said two uprights and removably connected to the other of said two uprights.

3. The article of claim 1 wherein said spanning element is removably connected to both of said uprights.

4. The article of claim 1 further comprising a detachable cover.

5. The article of claim 4 wherein said cover comprises at least one portion that is substantially transparent.

6. The article of claim 1 further comprising a base.

7. The article of claim 6 wherein said base has a height of no more than 5 cm.

8. The article of claim 7 wherein said base is hollow.

9. The article of claim 8 wherein said base defines a frame for a removable tray disposed therein.

10. The article of claim 6 wherein said base has a width of from 24 to 36 cm.

11. The article of claim 6 wherein said base has a depth of from 12 to 18 cm.

12. The article of claim 6 wherein each of said uprights presents a trapezoidal cross section.

13. The article of claim 6 wherein said article further comprises a protective covering face that extends between said uprights, said protective covering face terminating above said base such that the gap therebetween is sufficient for entry and egress by a rodent.

14. The article of claim 1 wherein each of said uprights has a height of from 4 to 8 cm.

15. The article of claim 14 wherein said spanning element is removably connected to at least one of said two uprights.

16. The article of claim 1 wherein said crosspiece comprises a gripping aid or a tactility increasing complement.

17. A kit comprising the article of claim 1, one or more rodenticide blocks, and instructions for securing said one or more rodenticide blocks on said spanning element.

18. The kit of claim 17 further comprising at least one of a brush.

19. The kit of claim 17 further comprising at least one replacement part for said article.

20. The kit of claim 17 wherein said one or more rodenticide blocks comprise an anticoagulant compound.
